(19) United States
(12) Patent Application Publication
(10) Pub. No.: US 2025/0155197 A1
(43) Pub. Date: May 15, 2025

(54) HEAT TREATMENT SYSTEM

(71) Applicant: NGK INSULATORS, LTD., Nagoya-Shi (JP)

(72) Inventors: Akinobu KOURA, Nagoya-Shi (JP); Yuya TANAKA, Nagoya-Shi (JP); Takeshi KOMAKI, Nagoya-Shi (JP)

(73) Assignee: NGK INSULATORS, LTD., Nagoya-Shi (JP)

(21) Appl. No.: 18/731,575

(22) Filed: Jun. 3, 2024

(30) Foreign Application Priority Data
Nov. 10, 2023 (JP) 2023-192487

(51) Int. Cl. F27B 9/24; F27B 9/38; F27B 9/39; F27D 3/00; F27D 5/00

(52) U.S. Cl. CPC F27B 9/2407; F27B 9/38; F27B 9/39; F27D 3/00; F27D 5/0012; F27B 2009/382; F27B 2009/384; F27D 2003/0019

(57) ABSTRACT

A heat treatment system may include: a heat treatment furnace; a return line; and a processor. The return line may include: a first processing line; a second processing line; an entrance line connected to the first processing line and the second processing line and located upstream of the first processing line and the second processing line on the return line; and an exit line connected to the first processing line and the second processing line and located downstream of the first processing line and the second processing line on the return line. The processor may include: a configured to process the saggar on the first processing line; and a configured to process the saggar on the second processing line.

### REFERENCE TO RELATED APPLICATIONS

This application claims priority to Japanese Patent Application No. 2023-192487, filed on Nov. 10, 2023, the entire contents of which are hereby incorporated by reference into the present application.

### TECHNICAL FIELD

The disclosure herein relates to a heat treatment system.

### BACKGROUND ART

Japanese Patent No. 7041300 describes a heat treatment system. The heat treatment system includes a heat treatment furnace, a return line, and a processing device. The heat treatment furnace includes an internal space in which a plurality of saggars is conveyed from an entrance to an exit. The return line is located outside the heat treatment furnace and conveys the plurality of saggars from the exit to the entrance. The processing device is located on the return line and processes the saggars on the return line.

### SUMMARY

In the heat treatment system above, the return line is a single line. Due to the processing to the saggars by the processing device on the return line being a bottleneck, it is difficult to increase the number of saggars to be processed in the heat treatment system.

The disclosure herein provides a technology that enables an increase in the number of saggars to be processed in a heat treatment system.

In a first aspect of the technology disclosed herein, a heat treatment furnace including an entrance, an exit, and an internal space in which a plurality of saggars is conveyed from the entrance to the exit; a return line located outside the heat treatment furnace and configured to convey the plurality of saggars from the exit to the entrance; and a processor located on the return line and configured to process the plurality of saggars on the return line. The return line may comprise: a first processing line onto which a saggar is conveyed; a second processing line located in parallel with the first processing line and onto which a saggar is conveyed; an entrance line connected to the first processing line and the second processing line and located upstream of the first processing line and the second processing line on the return line; and an exit line connected to the first processing line and the second processing line and located downstream of the first processing line and the second processing line on the return line. The processor may comprise: a first processing device configured to process the saggar on the first processing line; and a second processing device configured to process the saggar on the second processing line.

According to the configuration above, each saggar on the return line is processed by the first processing device on the first processing line or by the second processing device on the second processing line. This allows for an increase in the number of saggars to be processed in the heat treatment furnace, and thus a large number of saggars can be conveyed from the exit to the entrance of the heat treatment furnace via the return line. Thus, the number of saggars to be processed in the heat treatment furnace can be increased. Further, each saggar is processed on the first processing line or the second processing line. On the other hand, in a configuration in which one or more saggars are processed out of the first processing line (or out of the second processing line), the saggars need to be removed from the first processing line (or the second processing line) and then returned onto the first processing line (or the second processing line) after the saggars are processed. This increases the time for saggar conveyance on the return line. The configuration above can reduce the time for saggar conveyance on the return line as compared to the configuration in which the saggars are processed out of the first processing line (or outside the second processing line).

### BRIEF DESCRIPTION OF DRAWINGS

FIG. 1 schematically shows a heat treatment system according to a first embodiment.

FIG. 2 schematically shows a saggar before it is gripped by a gripper in a recovery unit according to the first embodiment.

FIG. 3 schematically shows a saggar being gripped by the gripper in the recovery unit according to the first embodiment.

FIG. 4 schematically shows a saggar positioned within an enclosure in the recovery unit according to the first embodiment, in which an inlet and an outlet are open.

FIG. 5 schematically shows a saggar positioned within the enclosure in the recovery unit according to the first embodiment, in which the inlet and the outlet are closed.

FIG. 6 schematically shows a saggar positioned directly above a downstream lifter in the recovery unit according to the first embodiment.

FIG. 7 schematically shows the downstream lifter at its lowered position in the recovery unit according to the first embodiment.

FIG. 8 schematically shows a cleaning unit according to the first embodiment.

FIG. 9 schematically shows filling unit according to the first embodiment.

FIG. 10 shows a schematic cross-sectional view of a surface smoothing unit according to the first embodiment.

FIG. 11 schematically shows unbranched lines, a branched line, and a processor in the heat treatment system according to the first embodiment.

FIG. 12 schematically shows the unbranched lines, the branched line, and the processor in the heat treatment system according to the first embodiment.

FIG. 13 schematically shows a heat treatment system according to a second embodiment.

FIG. 14 schematically shows a heat treatment system according to a third embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the technology disclosed herein according to the first aspect, the first processing line may be substantially parallel to the second processing line. This configuration allows for a reduction in the size of the return line as compared to a configuration in which the first processing line is substantially perpendicular to the second processing line.

In a third aspect of the technology disclosed herein according to the second aspect, the first processing line may be substantially perpendicular to each of the entrance line and the exit line. The second processing line may be substantially perpendicular to each of the entrance line and the exit line. In this configuration, the entrance line is substantially parallel to the exit line. Thus, a moving direction of saggars on the entrance line is the same as a moving direction of saggars on the exit line. That is, the saggars can be moved in the same direction (e.g., the direction from the exit toward the entrance) on the entrance line and the exit line.

In a fourth aspect of the technology disclosed herein according to the second or third aspect, a length of the first processing line may be substantially equal to a length of the second processing line. In this configuration, a moving distance of a saggar on the first processing line is substantially equal to a moving distance of a saggar on the second processing line. Therefore, the configuration above allows the time for saggar conveyance on the first processing line to be substantially equal to the time for saggar conveyance on the second processing line.

In a fifth aspect of the technology disclosed herein according to any one of the first to fourth aspects, each of the first processing device and the second processing device may be selected from a group consisting of: a recovery device configured to reverse the saggar and recover a material in the saggar, a cleaning device configured to clean the saggar, a filling device configured to fill the saggar with a material, and a surface smoothing device configured to smooth a surface of the material in the saggar. Generally, the time required to recover a heat-treated material from a saggar, the time required to clean the saggar, the time required to fill the saggar with a material, and the time required to smooth the surface of the material in the saggar are each longer than the time required to simply convey the saggar, and reducing these times enables an increase in the number of saggars to be processed in a heat treatment furnace. Since each of the first processing device and the second processing device is selected from the group consisting of the recovery device, the cleaning device, the filling device, and the surface smoothing device in the configuration above, the number of saggars to be processed in the heat treatment system can be increased.

### First Embodiment

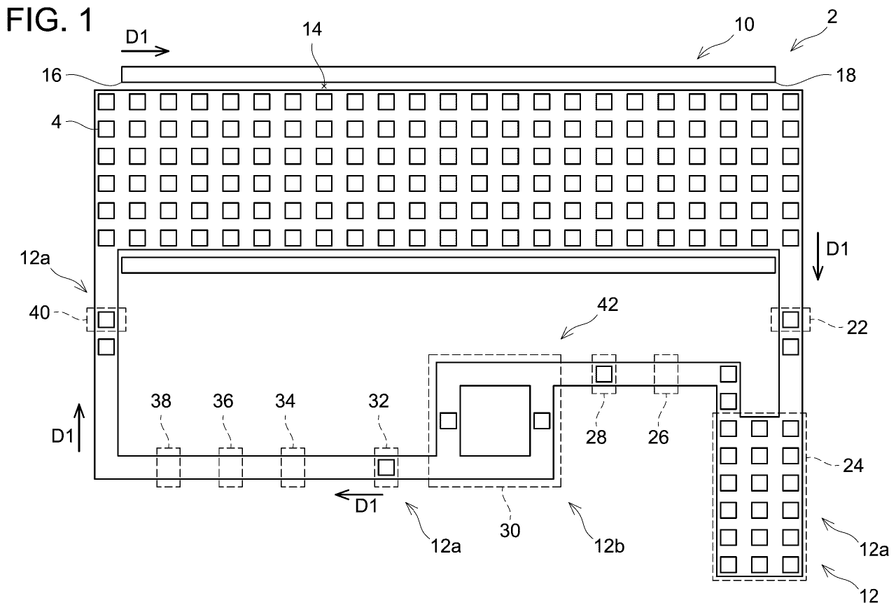

As shown in FIG. 1, a heat treatment system 2 comprises a heat treatment furnace 10 and a return line 12.

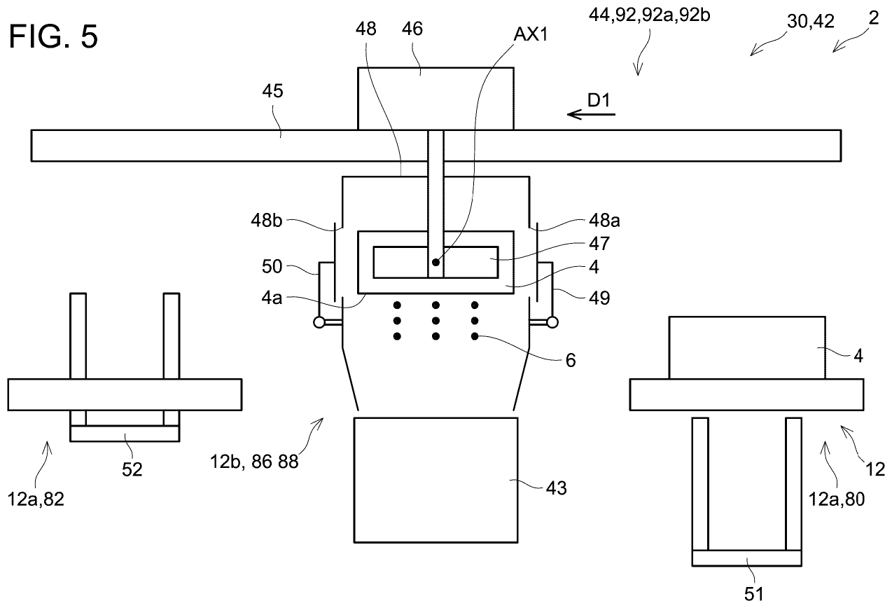

The heat treatment furnace 10 fires, i.e., heat-treats a material 6 (see FIG. 5) in saggars 4. The material 6 is for example a raw material for a ceramic capacitor, a positive-electrode material or a negative-electrode material of a lithium-ion battery.

The heat treatment furnace 10 is a heat insulating structure having a substantially cuboid shape. The heat treatment furnace 10 includes an internal space 14 therein. The heat treatment furnace 10 further includes an entrance 16 located at an end of the heat treatment furnace 10 and an exit 18 located at another end of the heat treatment furnace 10. The internal space 14 communicates with the outside of the heat treatment furnace 10 through the entrance 16 and the exit 18. The saggars 4 are stacked in a height direction (in an up-down direction) and these stacks of saggars 4 are aligned along a horizontal direction perpendicular to a conveying direction D1 (e.g., two saggars 4 are stacked in the height direction and six stacks of such saggars 4 are aligned along the horizontal direction perpendicular to the conveying direction D1). The stacks of saggars 4 are conveyed through the internal space 14 in the conveying direction D1 by rollers (not shown). In this way, the saggars 4 are conveyed from the entrance 16 to the exit 18.

The return line 12 is located outside the heat treatment furnace 10. The return line 12 conveys the saggars 4 in the conveying direction D1 by rollers (not shown). The saggars 4 are thereby conveyed from the exit 18 to the entrance 16.

The return line 12 comprises a plurality of unbranched lines 12a (in this embodiment, two unbranched lines 12a) and one or more branched lines 12b (in this embodiment, one branched line 12b). Each unbranched line 12a is an unbranched single line. The branched line 12b comprises a plurality of lines branching off from the unbranched lines 12a. The branched line 12b is interposed between the unbranched lines 12a. Each of the entrance 16 and the exit 18 of the heat treatment furnace 10 is connected to corresponding one of the unbranched lines 12a. The unbranched lines 12a and the branched line 12b will be described later in detail.

The heat treatment system 2 comprises an unstacking device 22, a cooling device 24, a disintegrating device 26, a first lifter 28, a recovery unit 30, a second lifter 32, a cleaning unit 34, a filling unit 36, a surface smoothing unit 38, and a stacking device 40. The unstacking device 22, the cooling device 24, the disintegrating device 26, the first lifter 28, the recovery unit 30, the second lifter 32, the cleaning unit 34, the filling unit 36, the surface smoothing unit 38, and the stacking device 40 are located on the return line 12. The unstacking device 22, the cooling device 24, the disintegrating device 26, the first lifter 28, the recovery unit 30, the second lifter 32, the cleaning unit 34, the filling unit 36, the surface smoothing unit 38, and the stacking device 40 are arranged in this order along the return line 12 from an upstream end of the return line 12 toward a downstream end thereof. The unstacking device 22, the cooling device 24, the disintegrating device 26, and the first lifter 28 are located on an unbranched line 12a closer to the upstream end of the return line 12 among the two unbranched lines 12a (which will be termed “upstream-side unbranched line 12a” hereinafter). The second lifter 32, the cleaning unit 34, the filling unit 36, the surface smoothing unit 38, and the stacking device 40 are located on the other unbranched line 12a closer to the downstream end of the return line 12 among the two unbranched lines 12a (which will be termed “downstream-side unbranched line 12a” hereinafter). The recovery unit 30 is located on the branched line 12b. Hereinafter, the recovery unit 30 may be termed a processor 42.

The unstacking device 22 unstacks each stack of saggars 4, which are stacked in the up-down direction, to individual unstacked saggars 4 after the stack of saggars 4 has been conveyed out from the exit 18. The saggars 4 are thereby arranged in a line along the conveying direction D1. The up-down direction is substantially perpendicular to the conveying direction D1. Further, as clearly shown in FIG. 1, although the stacks of saggars 4 are aligned along the horizontal direction perpendicular to the conveying direction D1 while being conveyed in the heat treatment furnace 10, the stacks are arranged not to aligned along the horizontal direction perpendicular to the conveying direction D1 (i.e., arranged to a line along the horizontal direction perpendicular to the conveying direction D1) when conveyed toward the unstacking device 22.

The cooling device 24 is configured to allow the saggars 4 to pass therethrough. The cooling device 24 cools the saggars 4 and the material 6 (see FIG. 10) in the saggars 4 by air or water flowing through at least one cooling pipe (not shown). As shown in FIG. 1, in the cooling device 24, multiple saggars 4 are aligned along the horizontal direction perpendicular to the conveying direction D1 (e.g., arranged in six rows in the horizontal direction) for conveyance. Conveying the saggars 4 in this arrangement reduces a conveying speed for the saggars 4 in the cooling device 24, thereby the material 6 in the saggars 4 can be cooled sufficiently.

The disintegrating device 26 disintegrates the material 6 (see FIG. 10), for example, by thrusting at least one pin into the material 6 in each saggar 4. As shown in FIG. 1, the saggars 4 on the way from the cooling device 24 to the disintegrating device 26 are conveyed in a line along the horizontal direction perpendicular to the conveying direction D1. The disintegrating device 26 processes the saggars 4 one by one.

The first lifter 28 lifts each saggar 4. Since the saggars 4 are conveyed to the first lifter 28 after processed one by one by the disintegrating device 26, the first lifter 28 lifts the saggars 4 one by one.

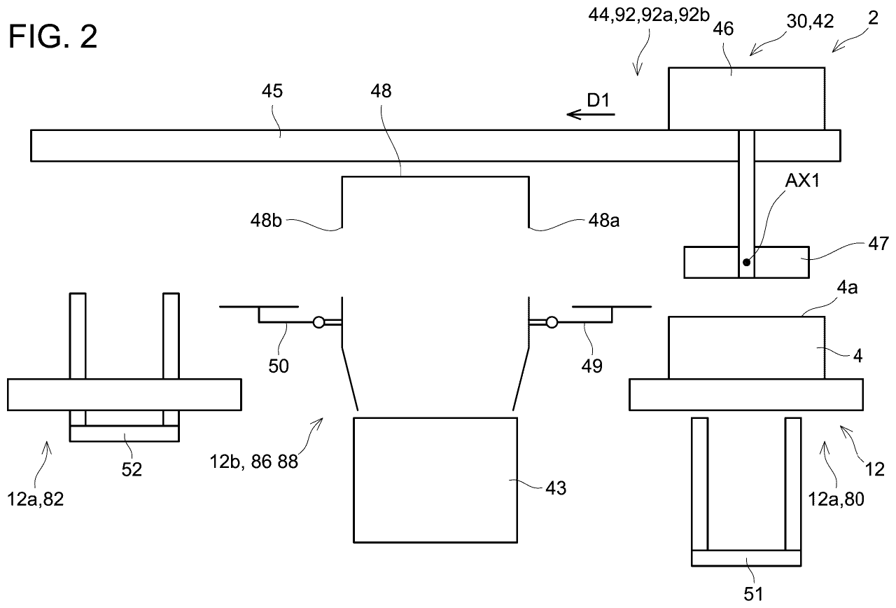

As shown in FIG. 2, the recovery unit 30 recovers the material 6 in the saggars 4 into a recovery container 43. The recovery unit 30 comprises a plurality of recovery devices 44 (in this embodiment, two recovery devices 44). The number of the recovery devices 44 is equal to the number of lines included in the branched line 12b (see FIG. 1). Each recovery device 44 processes the saggars 4 (i.e., recovers the material 6 therefrom) one by one.

Each recovery device 44 comprises a rail 45, a base 46, a gripper 47, an enclosure 48, an inlet cover 49, an outlet cover 50, an upstream lifter 51, and a downstream lifter 52. The rail 45 extends in the conveying direction D1.

The base 46 is attached to the rail 45 so as to be movable relative to the rail 45. The base 46 is guided by the rail 45 to move on the rail 45 in the conveying direction D1.

The gripper 47 is attached to the base 46. The gripper 47 grips a saggar 4 by pinching it. The gripper 47 is rotatable about a rotation axis AX1. The rotation axis AX1 extends in a direction substantially perpendicular to the conveying direction D1 (in the perpendicular direction to the sheet on which FIG. 2 is drawn). The gripper 47 turns the saggar 4 upside down by rotating while gripping the saggar 4.

The enclosure 48 is positioned above the recovery container 43. The recovery container 43 and the enclosure 48 are positioned between the two unbranched lines 12a. The enclosure 48 has a substantially box shape with an opening at its lower end. The lower end of the enclosure 48 faces an upper opening of the recovery container 43. The enclosure 48 includes an inlet 48a and an outlet 48b. The inlet 48a and the outlet 48b are aligned along the conveying direction D1. The inlet 48a faces the outlet 48b in the conveying direction D1. The saggar 4 and the gripper 47 can pass through the inlet 48a and the outlet 48b.

The inlet cover 49 is rotatably attached to the enclosure 48. The inlet cover 49 rotates to open/close the inlet 48a.

The outlet cover 50 is rotatably attached to the enclosure 48. The outlet cover 50 rotates to open/close the outlet 48b.

The upstream lifter 51 is located on the upstream-side unbranched line 12a. The upstream lifter 51 is configured to move upward and downward. The saggar 4 can be placed on the upstream lifter 51.

The downstream lifter 52 is located on the downstream-side unbranched line 12a. The downstream lifter 52 is configured to move upward and downward. The saggar 4 can be placed on the downstream lifter 52.

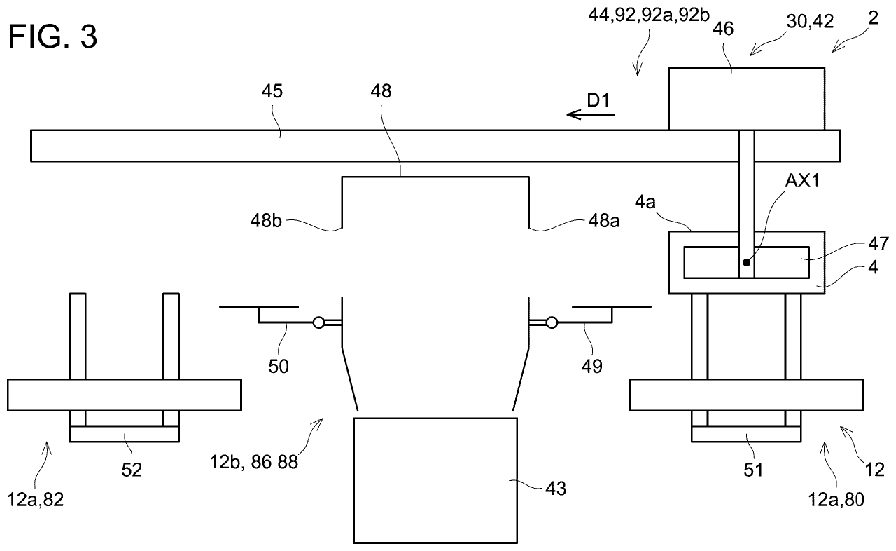

As shown in FIG. 3, to recover the material 6 in the saggar 4, the upstream lifter 51 first moves upward until its upper end is positioned above the upstream-side unbranched line 12a, while the saggar 4 is on the upstream-side unbranched line 12a. The saggar 4 is thereby placed on the upstream lifter 51 and lifted. Next, the gripper 47 grips the lifted saggar 4.

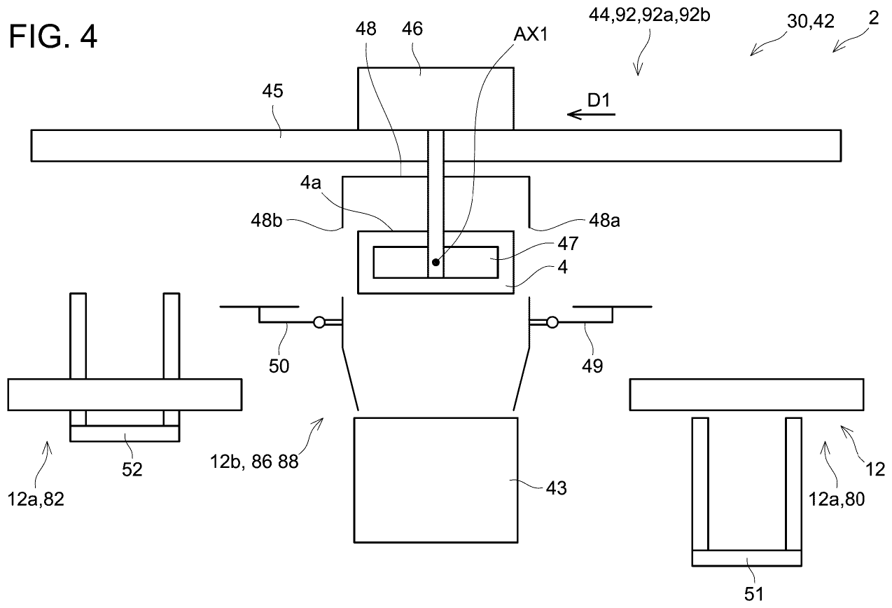

Then, as shown in FIG. 4, the base 46 moves, together with the gripper 47, in the conveying direction D1 and stops at a position immediately above the enclosure 48. The saggar 4 is thereby moved in the conveying direction D1 into the enclosure 48 through the inlet 48a, since the inlet cover 49 is not closing the inlet 48a. Further, as soon as the base 46 starts moving, the upstream lifter 51 moves downward until its upper end is positioned below the unbranched line 12a.

Then, as shown in FIG. 5, the inlet cover 49 rotates to close the inlet 48a. The outlet cover 50 also rotates to close the outlet 48b. The inlet cover 49 and the outlet cover 50 rotate simultaneously. The gripper 47 then rotates 180 degrees about the rotation axis AX1, thereby turning the saggar 4 upside down so that an opening 4a of the saggar 4 is oriented downward. As a result, the material 6 in the saggar 4 is taken out from the saggar 4 and recovered into the recovery container 43. Since the inlet 48a and the outlet 48b are closed, the material 6 is suppressed from escaping to the outside of the enclosure 48 through the inlet 48a and the outlet 48b.

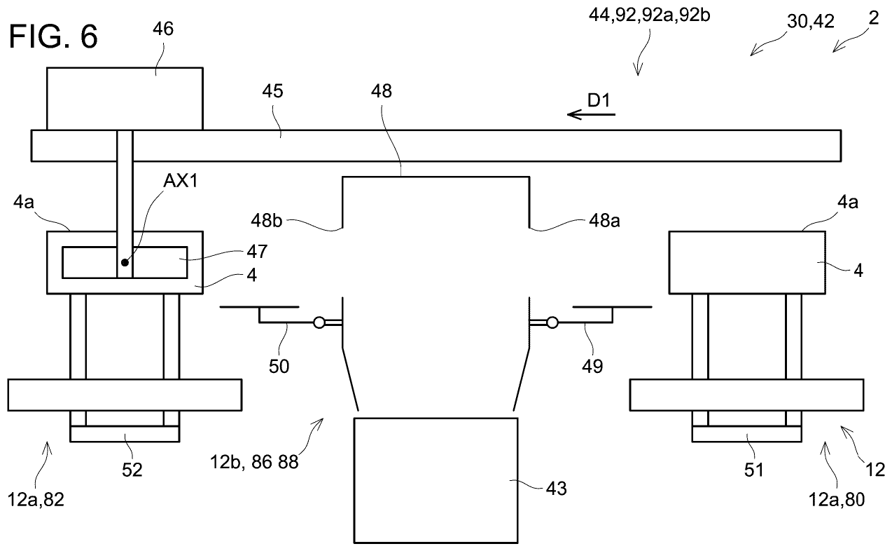

Then, as shown in FIG. 6, the gripper 47 rotates 180 degrees about the rotation axis AX1, thereby turning the saggar 4 upside down so that the opening 4a of the saggar 4 is oriented upward. The inlet cover 49 then rotates to open the inlet 48a. The outlet cover 50 also rotates to open the outlet 48b. The inlet cover 49 and the outlet cover 50 rotate simultaneously. Then, the base 46 moves together with the gripper 47 in the conveying direction D1 and stops at a position immediately above the downstream-side unbranched line 12a. The saggar 4 is thereby moved out of the enclosure 48 through the outlet 48b to a position immediately above the downstream-side unbranched line 12a. At this time, the upper end of the downstream lifter 52 is positioned above the downstream-side unbranched line 12a. Further, as soon as the base 46 starts moving, the upstream lifter 51 moves upward until its upper end is positioned above the upstream-side unbranched line 12a.

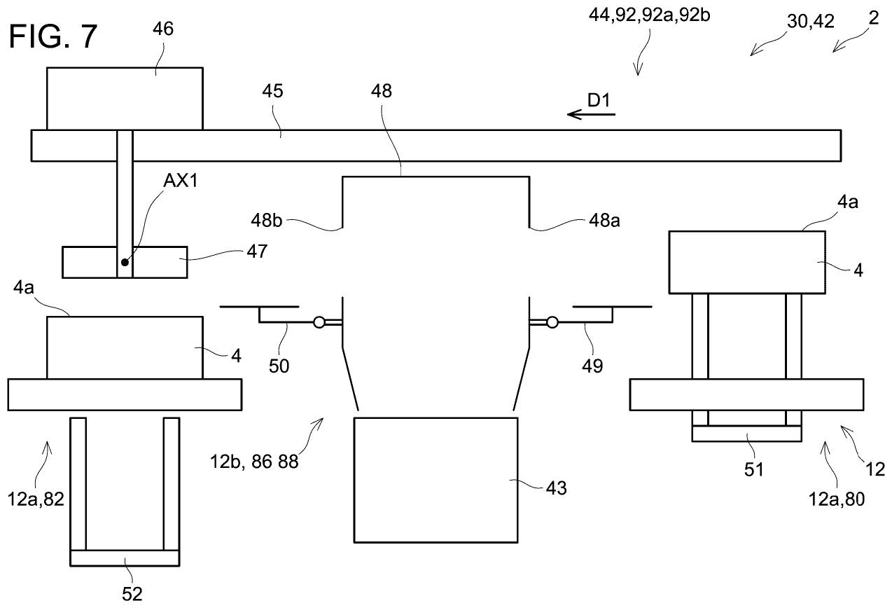

Then, as shown in FIG. 7, the gripper 47 releases the saggar 4. The saggar 4 is thereby placed on the downstream lifter 52. The downstream lifter 52 then moves downward until its upper end is positioned below the downstream-side unbranched line 12a. As a result, the saggar 4 is placed on the downstream-side unbranched line 12a. Finally, the base 46 moves together with the gripper 47 in the opposite direction to the conveying direction D1 and stops at a position immediately above the upstream-side unbranched line 12a. Thereafter, the recovery device 44 repeats the sequence of actions described above. In this way, the saggars 4 conveyed from the first lifter 28 are processed consecutively.

As shown in FIG. 1, the second lifter 32 lowers a saggar 4. After processed by the plurality of recovery devices 44, the saggars 4 are conveyed to the second lifter 32 one by one.

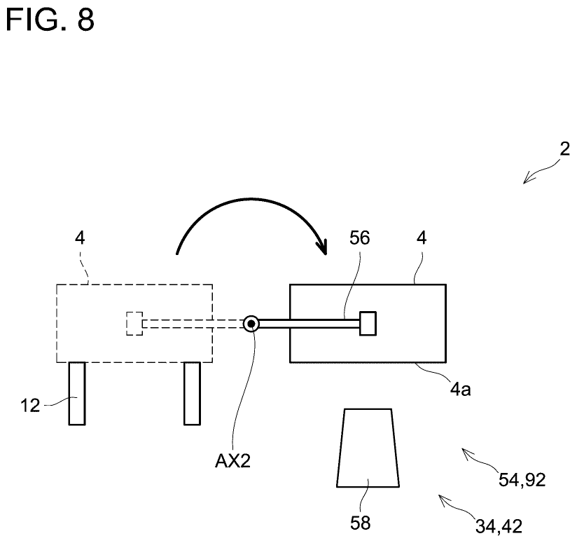

As shown in FIG. 8, the cleaning unit 34 cleans the saggars 4. The cleaning unit 34 comprises a cleaning device 54. Since the second lifter 32 lowers the saggars 4 one by one as shown in FIG. 1, the cleaning device 54 cleans the saggars 4 one by one.

As shown in FIG. 8, the cleaning device 54 comprises a reverser 56 and a discharger 58. The reverser 56 grips a saggar 4 by gripping it on the front and rear surfaces. The reverser 56 turns the saggar 4 upside down by rotating about a rotation axis AX2.

The discharger 58 is positioned to face the saggar 4, which has been turned upside down by the reverser 56, in the up-down direction. The discharger 58 discharges a gas upward toward the opening 4a of the saggar 4, thereby removing the material 6 (see FIG. 10) remaining in the saggar 4 therefrom.

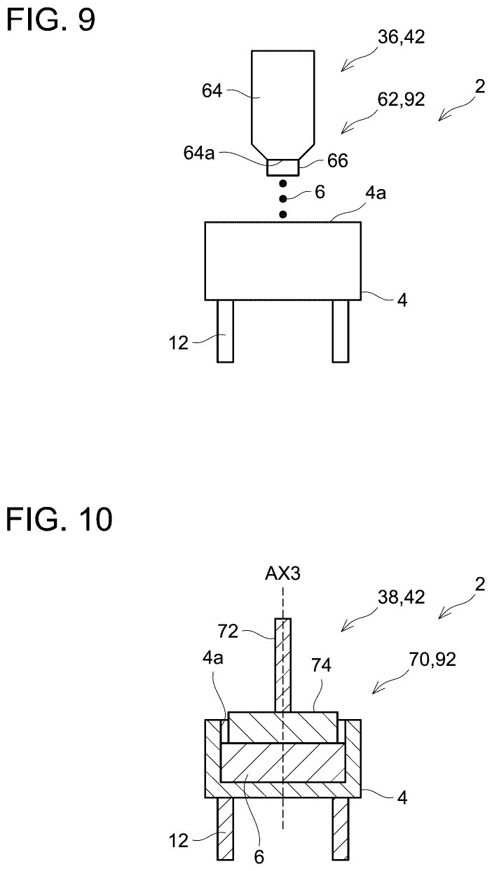

As shown in FIG. 9, the filling unit 36 fills the saggars 4 with a material 6 (i.e., pre-firing material 6). The filling unit 36 comprises a filling device 62. Since the saggars 4 are processed one by one by the cleaning device 54, the filling device 62 also fills the saggars 4 with the material 6 one by one.

The filling device 62 comprises a container 64 and a supplier 66. The container 64 stores therein the pre-firing material 6 to be supplied to the saggars 4.

The supplier 66 is connected to an outlet 64a of the container 64. The supplier 66 controls opening/closing of the outlet 64a and supplies a predetermined amount of the pre-firing material stored in the container 64 into each saggar 4 through the opening 4a thereof. In this way, the saggars 4 are filled with the material 6.

As shown in FIG. 10, the surface smoothing unit 38 smooths the surface of the material 6 in each saggar 4. The surface smoothing unit 38 comprises a surface smoothing device 70. Since the saggars 4 are processed one by one by the filling device 62, the surface smoothing device 70 also processes the material in the saggars 4 one by one.

The surface smoothing device 70 comprises a shaft 72 and a vane 74. The shaft 72 rotates about a rotation axis AX3.

The vane 74 is connected to an end of the shaft 72. The vane 74 rotates together with the shaft 72 about the rotation axis AX3, thereby smoothing the surface of the material 6 in the saggar 4.

As shown in FIG. 1, the stacking device 40 stacks the saggars 4 in the up-down direction. The stacks of saggars 4 are then conveyed to the entrance 16. As shown in FIG. 1, after processed by the surface smoothing device 70, the saggars 4 are conveyed in a line along the horizontal direction perpendicular to the conveying direction D1 to the stacking device 40, and then are stacked in the height direction (in the up-down direction) by the stacking device 40.

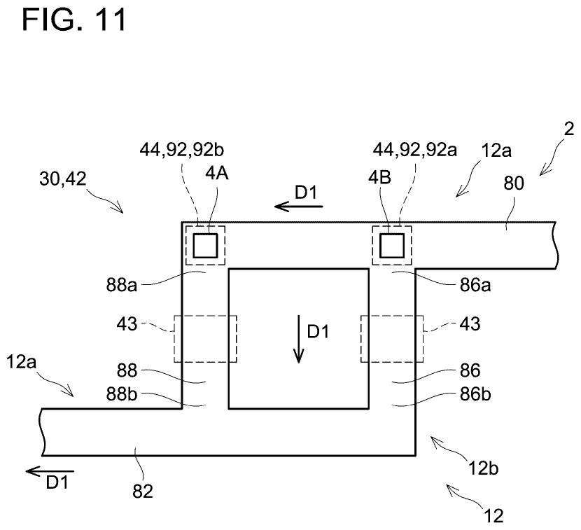

Now, the unbranched lines 12a and the branched line 12b are described. As shown in FIG. 11, the unbranched lines 12a comprise an entrance line 80 and an exit line 82. The entrance line 80 is located upstream of the branched line 12b on the return line 12. A width of the entrance line 80 in a width direction is for example larger than the width of the saggars 4 and twice the width of the saggars 4 at most. Therefore, it is impossible to align multiple saggars 4 along the width direction on the entrance line 80. Here, the width direction is a direction perpendicular to the conveying direction D1 and the up-down direction.

The exit line 82 is located downstream of the branched line 12b on the return line 12. The exit line 82 is located downstream of the entrance line 80 on the return line 12. The exit line 82 is substantially parallel to the entrance line 80. The conveying direction D1 in which the saggars 4 on the exit line 82 move is substantially parallel to the conveying direction D1 in which the saggars 4 on the entrance line 80 move. The exit line 82 is offset from the entrance line 80. A width of the exit line 82 in the width direction is substantially the same as the width of the entrance line 80 in the width direction.

The branched line 12b comprises a first processing line 86 and a second processing line 88. The first processing line 86 and the second processing line 88 are located in parallel with each other.

The first processing line 86 is connected to a first upstream connection point 86a of the entrance line 80. The entrance line 80 is located upstream of the first processing line 86. The first processing line 86 is connected to a first downstream connection point 86b of the exit line 82. The exit line 82 is located downstream of the first processing line 86. One of the recovery containers 43 is positioned on the first processing line 86. The first processing line 86 is substantially perpendicular to each of the entrance line 80 and the exit line 82. The conveying direction D1 in which the saggars 4 on the first processing line 86 move is substantially perpendicular to the conveying direction D1 in which the saggars 4 on the entrance line 80 move and the conveying direction D1 in which the saggars 4 on the exit line 82 move. A width of the first processing line 86 in the width direction is for example larger than the width of the saggars 4 and twice the width of the saggars 4 at most. Therefore, it is impossible to align multiple saggars 4 along the width direction on the first processing line 86. The width of the first processing line 86 in the width direction is for example the same as the width of the entrance line 80 in the width direction.

The second processing line 88 is connected to a second upstream connection point 88a of the entrance line 80. The second upstream connection point 88a is positioned downstream of the first upstream connection point 86a on the entrance line 80. The second processing line 88 is connected to a second downstream connection point 88b of the exit line 82. The second downstream connection point 88b is positioned downstream of the first downstream connection point 86b on the exit line 82. The other of the recovery containers 43 is positioned on the second processing line 88. The second processing line 88 is perpendicular to each of the entrance line 80 and the exit line 82. The second processing line 88 is substantially parallel to the first processing line 86. This allows for a reduction in the size of the return line 12 as compared to a configuration in which the second processing line 88 is substantially perpendicular to the first processing line 86. The conveying direction D1 in which the saggars 4 on the second processing line 88 move is the same as the conveying direction D1 in which the saggars 4 on the first processing line 86 move. The second processing line 88 is offset from the first processing line 86. A width of the second processing line 88 in the width direction is substantially the same as the width of the first processing line 86 in the width direction. A length of the second processing line 88 in the conveying direction D1 is the same as a length of the first processing line 86 in the conveying direction D1. Therefore, a moving distance of the saggars 4 on the second processing line 88 is substantially the same as a moving distance of the saggars 4 on the first processing line 86. Thus, the time required for each saggar 4 to move through the second processing line 88 is substantially the same as the time required for such saggar 4 to move through the first processing line 86. Here, it should be noted that an average moving speed of the saggars 4 on the second processing line 88 is substantially the same as an average moving speed of the saggars 4 on the first processing line 86.

The processor 42 is positioned on the branched line 12b. In this embodiment, the processor 42 corresponds to the recovery unit 30. The processor 42 comprises a plurality of processing devices 92 (two processing devices 92 in this embodiment). In this embodiment, the processing devices 92 correspond to the recovery devices 44. Hereinafter, one of the two processing devices 92 is termed a first processing device 92a and the other thereof is termed a second processing device 92b.

The first processing device 92a is positioned on the first processing line 86. The first processing device 92a processes saggars 4 on the first processing line 86, thereby recovering the material 6 from the saggars 4.

The second processing device 92b is positioned on the second processing line 88. The second processing device 92b processes saggars 4 on the second processing line 88.

Now, how a plurality of saggars 4 moves from the entrance line 80 to the exit line 82 is described. First, a plurality of saggars 4 (two saggars 4 in this embodiment) moves on the entrance line 80 in the conveying direction D1. Hereinafter, one of the two saggars 4 is termed a saggar 4A and the other thereof is termed a saggar 4B. The saggar 4A passes by the first upstream connection point 86a and moves to the second upstream connection point 88a. The saggar 4B moves to the first upstream connection point 86a.

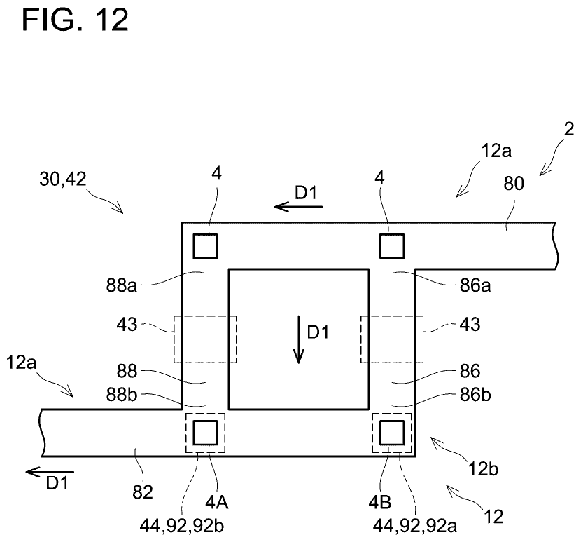

Then, along with the movement of the gripper 47 (see FIG. 2) of the recovery device 44, which is the first processing device 92a, the saggar 4B is moved along the first processing line 86 in the conveying direction D1 to a position immediately above the recovery container 43. The saggar 4B is then turned upside down so that the material 6 in the saggar 4B is recovered into the recovery container 43. Then, as shown in FIG. 12, along with the movement of the gripper 47 of the recovery device 44, which is the first processing device 92a, the saggar 4B is moved along the first processing line 86 in the conveying direction D1 to the first downstream connection point 86b. By the time the saggar 4B has reached the first downstream connection point 86b, another saggar 4 on the entrance line 80 moves to the first upstream connection point 86a.

Further, as shown in FIG. 11, along with the movement of the gripper 47 (see FIG. 2) of the recovery device 44, which is the second processing device 92b, the saggar 4A is moved along the second processing line 88 in the conveying direction D1 to a position immediately above the recovery container 43. The saggar 4A is then turned upside down so that the material 6 in the saggar 4A is recovered into the recovery container 43. Then, along with the movement of the gripper 47 of the recovery device 44, which is the second processing device 92b, the saggar 4A is moved along the second processing line 88 in the conveying direction D1 to the second downstream connection point 88b. By the time the saggar 4A has reached the second downstream connection point 88b, another saggar 4 on the entrance line 80 moves to the second upstream connection point 88a.

In this embodiment, the saggars 4B and 4A move simultaneously along the first processing line 86 and along the second processing line 88, respectively. Further, the saggars 4B and 4A are simultaneously turned upside down. That is, these two saggars 4 are processed simultaneously by their corresponding processing devices 92.

Lastly, after moved off from the first processing line 86 and the second processing line 88, the saggars 4B and 4A move on the exit line 82 in the conveying direction D1.

### Effects

In the above embodiment, the processing devices 92 are positioned on the first processing line 86 and the second processing line 88, respectively. Thus, the saggars 4 are processed by the plurality of processing devices 92 positioned on the first processing line 86 and the second processing line 88. Therefore, the processing devices 92 cannot be a bottleneck and a large number of saggars 4 can be processed. Thus, the number of saggars 4 to be processed in the heat treatment furnace can be increased, and thus a large number of saggars 4 can be conveyed from the exit 18 to the entrance 16 of the heat treatment furnace via the return line 12. The heat treatment system 2 thus allows for an increase in the number of saggars 4 to be heat treated.

### Second Embodiment

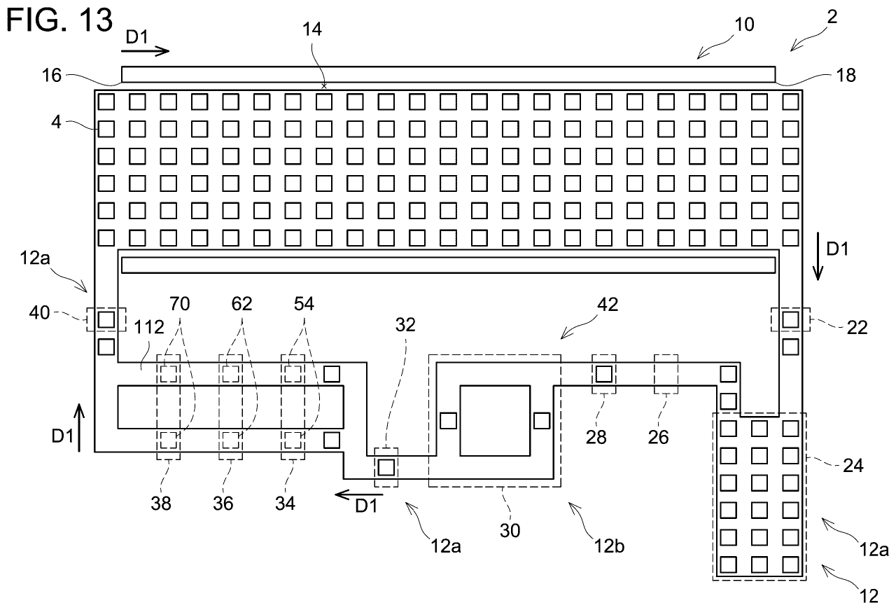

Referring to FIG. 13, a second embodiment is described. For the second embodiment, only differences from the first embodiment are described. As shown in FIG. 13, the return line 12 further comprises a parallel line 112. The parallel line 112 is connected to the downstream-side unbranched line 12a. The parallel line 112 is connected in parallel with the downstream-side unbranched line 12a. After lowered by the second lifter 32, the saggars 4 are conveyed onto the downstream-side unbranched line 12a and the parallel line 112 alternately.

The cleaning unit 34 comprises a plurality of cleaning devices 54 (two cleaning devices 54 in this embodiment). One of the cleaning devices 54 is positioned on the downstream-side unbranched line 12a and the other thereof is positioned on the parallel line 112.

The filling unit 36 comprises a plurality of filling devices 62 (two filling devices 62 in this embodiment). One of the filling devices 62 is positioned on the downstream-side unbranched line 12a and the other thereof is positioned on the parallel line 112.

The surface smoothing unit 38 comprises a plurality of surface smoothing devices 70 (two surface smoothing devices 70 in this embodiment). One of the surface smoothing devices 70 is positioned on the downstream-side unbranched line 12a and the other thereof is positioned on the parallel line 112.

In this embodiment, a cleaning device 54, the filling device 62, and a surface smoothing device 70 are arranged in this order along the downstream-side unbranched line 12a, while the other cleaning device 54, the other filling device 62, and the other surface smoothing device 70 are arranged in this order along the parallel line 112.

### Third Embodiment

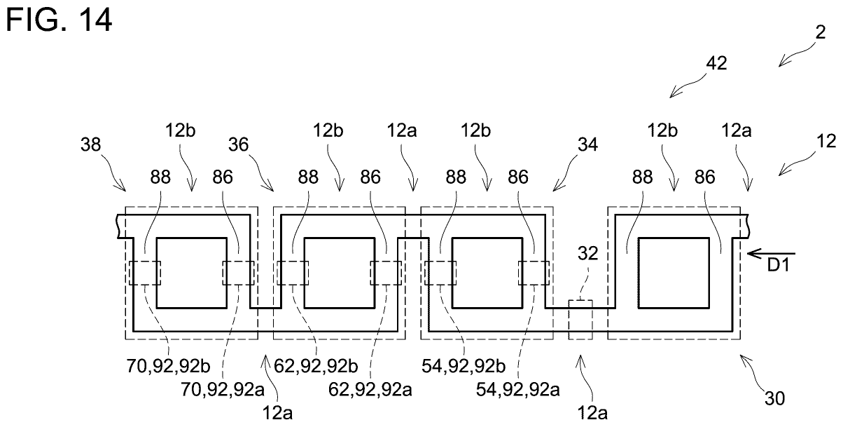

Referring to FIG. 14, a third embodiment is described. For the third embodiment, only differences from the first embodiment are described. As shown in FIG. 14, the return line 12 comprises five unbranched lines 12a and four branched lines 12b. The unbranched lines 12a and the branched lines 12b are arranged alternately.

The recovery unit 30 is positioned on the most upstream-side branched line 12b of the four branched lines 12b. The cleaning unit 34 is positioned on a branched line 12b located downstream of the branched line 12b on which the recovery unit 30 is positioned. The filling unit 36 is positioned on a branched line 12b located downstream of the branched line 12b on which the cleaning unit 34 is positioned. The surface smoothing unit 38 is positioned on a branched line 12b located downstream of the branched line 12b on which the filling unit 36 is positioned. The recovery unit 30, the cleaning unit 34, the filling unit 36, and the surface smoothing unit 38 each correspond to a processor 42.

The cleaning unit 34 comprises a plurality of cleaning devices 54 (two cleaning devices 54 in this embodiment). The cleaning devices 54 correspond to processing devices 92. The number of the cleaning devices 54 is equal to the number of lines included in the branched line 12b. Each cleaning device 54 processes the saggars 4 one by one. One of the cleaning devices 54 (i.e., a first processing device 92a) is positioned on the first processing line 86, while the other cleaning device 54 (i.e., a second processing device 92b) is positioned on the second processing line 88.

The filling unit 36 comprises a plurality of filling devices 62 (two filling devices 62 in this embodiment). The filling devices 62 correspond to processing devices 92. The number of the filling devices 62 is equal to the number of lines included in the branched line 12b. Each filling device 62 processes the saggars 4 one by one. One of the filling devices 62 (i.e., a first processing device 92a) is positioned on the first processing line 86, while the other filling device 62 (i.e., a second processing device 92b) is positioned on the second processing line 88.

The surface smoothing unit 38 comprises a plurality of surface smoothing devices 70 (two surface smoothing devices 70 in this embodiment). The surface smoothing devices 70 correspond to processing devices 92. The number of the surface smoothing devices 70 is equal to the number of lines included in the branched line 12b. Each surface smoothing device 70 processes the saggars 4 one by one. One of the surface smoothing devices 70 (i.e., a first processing device 92a) is positioned on the first processing line 86, while the other surface smoothing device 70 (i.e., a second processing device 92b) is positioned on the second processing line 88.

### VARIANT

In one embodiment, each branched line 12b may include three or more processing lines.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment system comprising:
a heat treatment furnace including an entrance, an exit, and an internal space in which a plurality of saggars is conveyed from the entrance to the exit;
a return line located outside the heat treatment furnace and configured to convey the plurality of saggars from the exit to the entrance; and
a processor located on the return line and configured to process the plurality of saggars on the return line,
wherein
the return line comprises:
a first processing line onto which a saggar is conveyed;
a second processing line located in parallel with the first processing line and onto which a saggar is conveyed;
an entrance line connected to the first processing line and the second processing line and located upstream of the first processing line and the second processing line on the return line; and
an exit line connected to the first processing line and the second processing line and located downstream of the first processing line and the second processing line on the return line, and
the processor comprises:
a first processing device configured to process the saggar on the first processing line; and
a second processing device configured to process the saggar on the second processing line.

2. The heat treatment system according to claim 1, wherein the first processing line is substantially parallel to the second processing line.

3. The heat treatment system according to claim 2, wherein
the first processing line is substantially perpendicular to each of the entrance line and the exit line, and
the second processing line is substantially perpendicular to each of the entrance line and the exit line.

4. The heat treatment system according to claim 2, wherein a length of the first processing line is substantially equal to a length of the second processing line.

5. The heat treatment system according to claim 1, wherein each of the first processing device and the second processing device is selected from a group consisting of: a recovery device configured to reverse the saggar and recover a material in the saggar, a cleaning device configured to clean the saggar, a filling device configured to fill the saggar with a material, and a surface smoothing device configured to smooth a surface of the material in the saggar.
